(19) United States
(12) Patent Application Publication
(10) Pub. No.: US 2009/0120576 A1
(43) Pub. Date: May 14, 2009

(54) ADHESIVE STRIP THAT CAN BE ACTIVATED BY HEAT AND IS BASED ON NITRILE RUBBER AND POLYVINYL BUTYRAL FOR STICKING TOGETHER ELECTRONIC COMPONENTS AND STRIP CONDUCTORS

(75) Inventors: Christian Ring, Hamburg (DE); Thorsten Krawinkel, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, Hamburg (DE)

(21) Appl. No.: 11/718,350

(22) PCT Filed: Nov. 11, 2005
(86) PCT No.: PCT/EP2005/055912

§ 371 Date: Dec. 10, 2008

(30) Foreign Application Priority Data
Nov. 29, 2004 (DE) 10 2004 057 651.3

(51) Int. Cl. C09J 7/00; C09J 109/02; C09J 163/00

(52) U.S. Cl. 156/330; 525/185; 524/512

(57) ABSTRACT

Heat-activable adhesive tape for producing and further processing flexible conductor tracks, with an adhesive composed at least of
a. an acrylonitrile-butadiene copolymer, with a weight fraction of 40% to 80% by weight,
b. a polyvinyl acetal, with a weight fraction of 2% to 30% by weight,
c. an epoxy resin, with a weight fraction of 10% to 50% by weight, and
d. a hardener,
   the epoxide groups being chemically crosslinked with the hardener at high temperatures.

The invention relates to a heat-activable adhesive tape of low fluidity at high temperatures for bonding electronic components and flexible printed conductor tracks (flexible printed circuit boards, FPCBs).

Flexible printed circuit boards are nowadays employed in a multiplicity of electronic devices such as mobile phones, radios, computers, printers and many more. They are constructed from layers of copper and a high-melting resistant thermoplastic: mostly polyimide, less often polyester. These FPCBs are frequently produced using adhesive tapes with particularly exacting requirements. On the one hand, for producing the FPCBs, the copper foils are bonded to the polyimide films; on the other hand, individual FPCBs are also bonded to one another, in which case polyimide bonds to polyimide. In addition to these applications, the FPCBs are also bonded to other substrates.

The adhesive tapes used for these bonding tasks are subject to very exacting requirements. Since very high bond performances must be attained, the adhesive tapes used are generally heat-activable tapes, which are processed at high temperatures. These adhesive tapes must not emit volatile constituents in the course of this high temperature load during the bonding of the FPCBs, which often takes place at temperatures around 200° C. In order to achieve a high level of cohesion the adhesive tapes ought to crosslink during this temperature load. High pressures during the bonding operation make it necessary for the flowability of the adhesive tapes at high temperatures to be low. This is achieved by high viscosity in the uncrosslinked adhesive tape or by very rapid crosslinking. Moreover, the adhesive tapes must also be solder bath resistant, in other words must for a short time withstand a temperature load of 288° C.

For this reason the use of pure thermoplastics is not rational, despite the fact that they melt very readily, ensure effective wetting of the substrates to be bonded and lead to very rapid bonding within a few seconds. At high temperatures, though, they are so soft that they tend to swell out of the bondline under pressure in the course of bonding. Accordingly there is no solder bath resistance either.

For crosslinkable adhesive tapes it is usual to use epoxy resins or phenolic resins, which react with specific hardeners to form polymeric networks. In this specific case the phenolic resins cannot be used, since in the course of crosslinking they generate elimination products, which are released and, in the course of curing or, at the latest, in the solder bath, lead to blistering.

Epoxy resins are employed primarily in structural adhesive bonding and, after curing with appropriate crosslinkers, produce very brittle adhesives, which indeed achieve high bond strengths but possess virtually no flexibility.

Increasing the flexibility is vital for use in FPCBs. On the one hand the bond is to be made using an adhesive tape which ideally is wound onto a roll; on the other hand the conductor tracks in question are flexible, and must also be bent, readily apparent from the example of the conductor tracks in a laptop, where the foldable screen is connected via FPCBs to the further circuits.

Flexibilizing these epoxy resin adhesives is possible in two ways. First, there exist epoxy resins flexibilized with elastomer chains, but the flexibilization they experience is limited, owing to the very short elastomer chains. The other possibility is to achieve flexibilization through the addition of elastomers, which are added to the adhesive. This version has the drawback that the elastomers are not crosslinked chemically, meaning that the only elastomers that can be used are those which at high temperatures still retain a high viscosity.

Because the adhesive tapes are produced generally from solution it is frequently difficult to find elastomers of a sufficiently long-chain nature not to flow at high temperatures while being still soluble in conventional solvents.

Production via a hotmelt operation is possible but very difficult in the case of crosslinking systems, since it is necessary to prevent premature crosslinking during the production operation.

Adhesives based on (hydrogenated) nitrile rubber and polyvinyl acetals, principally polyvinyl butyral, are known and are described for example in JP 03 068673 A and JP 61 143 480 A. In those cases the amount of epoxy resins is sufficiently high that the products in question are no longer flexible adhesive tapes, but rather adhesives. Their use in flexible conductor tracks is not described. JP 04 057 878 A, JP 04 057 879 A, JP 04 057 880 A, and JP 03 296 587 A describe adhesives for copper-polyimide composites, of the kind also used in flexible conductor tracks, that are based on nitrile rubber, polyvinyl butyral, and epoxy resins. In all of these specifications an α,β-unsaturated compound, such as, for example, an epoxy acrylate or the like, is needed for crosslinking.

It is an object of the invention, therefore, to provide an adhesive tape which is heat-activable, crosslinks under heat, flows well under heat onto the substrate to be bonded, displays effective adhesion to polyimide, and in the uncrosslinked state is soluble in organic solvents.

This object is achieved by means of an adhesive tape as characterized in more detail in the main claim. The dependent claims provide advantageous developments of the subject matter of the invention.

The invention accordingly provides a heat-activable adhesive tape for bonding electronic components and conductor tracks, comprising an adhesive composed at least of
a. an acrylonitrile-butadiene copolymer, with a weight fraction of 40% to 80% by weight,
b. a polyvinyl acetal, with a weight fraction of 2% to 30% by weight,
c. an epoxy resin, with a weight fraction of 10% to 50% by weight, and
d. a hardener,
   the epoxide groups being chemically crosslinked with the hardener at high temperatures.

The general expression “adhesive tape” for the purposes of this invention embraces all sheetlike structures, such as two-dimensionally extended sheets or sheet sections, tapes with extended length and limited width, tape sections, diecuts, and the like.

In contrast to the prior art, where an α,β-unsaturated compound such as, for example, an epoxy acrylate or the like is needed for crosslinking, the crosslinking in the present invention takes place under the sole inducement of chemical reaction of the epoxide groups with different hardeners in the heat.

Nitrile rubbers which can be employed in adhesives of the invention include in particular all of acrylonitrile-butadiene rubbers having an acrylonitrile content of 15% to 50% by weight. Additionally, copolymers of acrylonitrile-butadiene and isoprene can also be used. In that case the fraction of 1,2-linked butadiene is variable. The aforementioned polymers may have various degrees of hydrogenation; fully hydrogenated polymers with a double bond fraction of below 1% can also be utilized.

Commercially, systems of this kind are commercialized, for example, under the name Nipol or Breon from the company Zeon; hydrogenated systems are available under the name Zetpol from Zeon or as Therban from Lanxess, in different grades.

It is found that the nitrile rubbers with relatively high acrylonitrile contents produce better bonding performance. Likewise advantageous for a strong adhesive bond is a higher molecular weight, in which case it is necessary to ensure that the polymer can still be brought into solution.

Polyvinyl acetals in the sense of the invention are all polyvinyl formals having different polyvinyl alcohol contents, and, preferably, polyvinyl butyrals obtained from polyvinyl alcohol. The polyvinyl alcohol content may fluctuate between 5% and 40% by weight. Polyvinyl butyrals are preferred, since they are much easier to obtain in solution.

Both the nitrile rubbers and the polyvinyl butyrals can be dissolved in short-chain alcohols and ketones such as ethanol or butanone. Butanone is preferred, since the remaining components, particularly the epoxy resins, are more soluble in butanone.

Epoxy resins are usually understood to be not only monomeric but also oligomeric compounds containing more than one epoxide group per molecule. They may be reaction products of glycidyl esters or epichlorohydrin with bisphenol A or bisphenol F or mixtures of these two. Likewise suitable for use are epoxy novolak resins, obtained by reacting epichlorohydrin with the reaction product of phenols and formaldehyde. Monomeric compounds containing two or more epoxide end groups, used as diluents for epoxy resins, can also be employed. Likewise suitable for use are elastically modified epoxy resins.

Examples of epoxy resins are Araldite™ 6010, CY-281™, ECN™ 1273, ECN™ 1280, MY 720, RD-2 from Ciba Geigy, DER™ 331, 732, 736, DEN™ 432 from Dow Chemicals, Epon™ 812, 825, 826, 828, 830 etc. from Shell Chemicals, HPT™ 1071, 1079, likewise from Shell Chemicals, and Bakelite™ EPR 161, 166, 172, 191, 194 etc. from Bakelite AG.

Commercial aliphatic epoxy resins are, for example, vinylcyclohexane dioxides such as ERL-4206, 4221, 4201, 4289 or 0400 from Union Carbide Corp.

Elasticized elastomers are available from Noveon under the name Hycar.

Epoxy diluents, monomeric compounds containing two or more epoxide groups, are for example Bakelite™ EPD KR, EPD Z8, EPD HD, EPD WF, etc. from Bakelite AG or Polypox™ R 9, R12, R 15, R 19, R 20 etc. from UCCP.

With further preference the adhesive tape comprises more than one epoxy resin.

Suitable hardeners include the following substances, as described in more detail in U.S. Pat. No. 3,970,608 A:
polyfunctional aliphatic amines, such as triethylenetetramine for example
polyfunctional aromatic amines, such as isophoronediamine for example
guanidines, such as dicyandiamide for example
polyhydric phenols
polyhydric alcohols
polyfunctional mercaptans
polybasic carboxylic acids
acid anhydrides with one or more anhydride groups

The chemical crosslinking of the hardeners with the epoxy resins produces very high strengths within the adhesive film. The bond strengths to the polyimide as well, however, are extremely high.

In order to increase the adhesion it is also possible to add tackifier resins compatible with the elastomers.

Examples of tackifiers which can be used in pressure-sensitive adhesives of the invention include non-hydrogenated, partially hydrogenated or fully hydrogenated resins based on rosin and rosin derivatives, hydrated polymers of dicyclopentadiene, non-hydrogenated or partially, selectively or fully hydrogenated hydrocarbon resins based on C₅, C₅/C₉ or C₉ monomer streams, polyterpene resins based on α-pinene and/or β-pinene and/or δ-limonene, hydrogenated polymers of preferably pure C₈ and C₉ aromatics. Aforementioned tackifier resins may be used either alone or in a mixture.

Further additives which can be used typically include:
primary antioxidants, such as sterically hindered phenols
secondary antioxidants, such as phosphites or thioethers
in-process stabilizers, such as C-radical scavengers
light stabilizers, such as UV absorbers or sterically hindered amines
processing assistants
endblock reinforcer resins
fillers, such as silicon dioxide, glass (ground or in the form of beads), aluminum oxides, zinc oxides, calcium carbonates, titanium dioxides, carbon blacks, metal powders, etc.
color pigments and dyes and also optical brighteners
if desired, further polymers, preferably elastomeric in nature.

Through the use of plasticizers it is possible to raise the elasticity of the crosslinked adhesive. Plasticizers which can be used include, for example, low molecular mass polyisoprenes, polybutadienes, polyisobutylenes or polyethylene glycols and polypropylene glycols.

Since the two polymers used do not have an excessively low viscosity even at high temperatures, there is no escape of adhesive from the bondline in the course of adhesive bonding or hot pressing. During this procedure, the epoxy resins crosslink with the hardeners to form a three-dimensional network.

By adding compounds known as accelerators it is possible to increase the reaction rate much further.

Examples of possible accelerators include the following:
tertiary amines, such as benzyldimethylamine, dimethylaminomethylphenol, tris(dimethylaminomethyl)phenol
boron trihalide-amine complexes
substituted imidazoles
triphenylphosphine

Ideally the epoxy resins and the hardeners are employed in a proportion such that the molar fraction of epoxide groups and hardener groups is just equivalent.

The ratio between hardener groups and epoxide groups, however, can be varied within wide ranges; for sufficient crosslinking, neither of the two groups should be present in more than a four-fold molar equivalent excess.

To produce the adhesive tape the constituents of the adhesive are dissolved in a suitable solvent, butanone for example, and the solution is coated onto a flexible substrate provided with a release layer, such as a release paper or release film, for example, and the coating is dried, so that the composition can be easily removed again from the substrate. Following appropriate converting, diecuts, rolls or other shapes can be produced at room temperature. Corresponding shapes are then adhered, preferably at elevated temperature, to the substrate to be bonded, polyimide for example.

It is also possible to coat the adhesive directly onto a polyimide backing. Adhesive sheets of this kind can then be used for masking copper conductor tracks for FPCBs.

It is not necessary for the bonding operation to be a one-stage process; instead, the adhesive tape can first be adhered to one of the two substrates by carrying out hot lamination. In the course of the actual hot bonding operation with the second substrate (second polyimide sheet or copper foil), the epoxide groups then fully or partly cure and the bondline reaches the high bond strength.

The admixed epoxy resins and the hardeners should preferably not yet enter into any chemical reaction at the lamination temperature, but instead should react with one another only on hot bonding.

As a result of the use of the polyvinyl acetal, the temperature stability, in particular, of the crosslinked adhesive is significantly improved.

The adhesive tape crosslinks preferably at temperatures above 150° C.

### EXAMPLES

The invention is described in more detail below by a number of examples, without restricting the invention in any way whatsoever.

### Example 1

50% by weight of Breon N41H80 (nitrile rubber from Zeon, with an acrylonitrile content of 41% by weight and a Mooney viscosity ML 1+4 at 100° C. of 72 to 88) are dissolved together with 15% by weight of Mowital B 60 HH (polyvinyl butyral from Kuraray, with a polyvinyl alcohol content of 12% to 16% by weight) in butanone. Then 30% by weight of Bakelite EPR 166 (epoxy resin with an epoxide equivalent of 184, from Bakelite) and 5% by weight of Dyhard 100-S (dicyandiamide from Degussa) are added. When all of the ingredients apart from the insoluble dicyandiamide are in solution, the solution is coated out onto a release paper which has a release layer, to give, after drying, a coat thickness of 25 μm.

### Example 2

60% by weight of Therban C 4369 (hydrogenated nitrile rubber from Lanxess, with a 43% by weight acrylonitrile content, a Mooney viscosity at 100° C. of about 95, and a double bond content of 5.5%) is dissolved with 10% by weight of Mowital B 75H (polyvinyl butyral from Kuraray, with a polyvinyl alcohol content of 18% to 21% by weight) as described in example 1 and, as in example 1, Bakelite EPR 166 (26% by weight) and Dyhard 100-S (4% by weight) are added.

### Example 3

### Comparative

70% by weight of Breon N41H80 is dissolved in butanone. Then 25% by weight of Bakelite EPR 166 and 5% by weight of Dyhard 100-S are added.

### Example 4

### Comparative

This example corresponds to example 1, albeit with a modified composition: 30% by weight of nitrile rubber, 10% by weight of polyvinyl butyral, 54% by weight of epoxy resin, and 6% by weight of hardener.

Bonding of FPCBs with the Adhesive Tape Produced

Two FPCBs are bonded using in each case one of the adhesive tapes produced in accordance with examples 1 to 4. For this purpose the adhesive tape is laminated onto the polyimide sheet of the polyimide/copper foil FPCB laminate at 100° C., the adhesive strip being somewhat shorter than the FPCB that is to be bonded, so as subsequently to have a grip tab. Subsequently a second polyimide sheet of a further FPCB is bonded to the adhesive tape and the whole assembly is compressed in a heatable Bürkle press at 200° C. and a pressure of 1.3 MPa for one hour.

### Test Methods

The properties of the adhesive sheets produced in accordance with the examples specified above are investigated by the following test methods.

T-Peel Test with FPCB

Using a tensile testing machine from Zwick, the FPCB/adhesive tape/FPCB assemblies produced in accordance with the process described above are peeled from one another at an angle of 180° and with a rate of 50 mm/min, and the force required, in N/cm, is measured. The measurements are made at 20° C. and 50% relative humidity. Each measurement value is determined three times.

### Temperature Stability

In analogy to the T-peel test described, the FPCB assemblies produced in accordance with the process described above are suspended so that one of the two grip tabs formed is fixed at the top, while on the other grip tab a weight of 500 g is fastened, so that an angle of 180° is formed between the two FPCBs. The static peel test takes place at 70° C. The parameter measured is the static peel travel in mm/h.

### Solder Bath Resistance

The FPCB assemblies bonded in accordance with the process described above are laid for 10 seconds onto a solder bath which is at a temperature of 288° C. The bond is rated solder bath resistant if there is no formation of air bubbles which caused the polyimide sheet of the FPCB to inflate. The test is rated as failed if there was even slight formation of bubbles.

### Results:

For adhesive assessment of the abovementioned examples the T-peel test was conducted first of all.

The results are given in Table 1.

TABLE 1

| | T-peel test [N/cm] |
|---|---|
| Example 1 | 14.3 |
| Example 2 | 15.4 |
| Example 3, comparative | 10.7 |
| Example 4, comparative | 5.6 |

As can be seen from the examples, it is possible through the use of a mixture of nitrile rubber and polyvinyl butyral to obtain a significantly higher bond strength than by means of adhesives with nitrile rubber alone. If the epoxy resin fraction is too high, as in example 4, the bond strengths then drop, owing to the high level of brittleness.

The temperature stability of the adhesive tapes was measured using the static peel test, whose values can be found in Table 2.

TABLE 2

| | Static T-peel test at 70° C. [mm/h] |
|---|---|
| Example 1 | 3 |
| Example 2 | 2 |
| Example 3 | 16 |
| Example 4 | 34 |

As can be seen, the temperature stability in the case of the reference specimens is lower than in the case of examples 1 and 2.

The solder bath test was passed by all 4 examples.

1. Heat-activable adhesive tape for producing and further processing flexible conductor tracks, with an adhesive composed at least of
a. an acrylonitrile-butadiene copolymer, with a weight fraction of 40% to 80% by weight,
b. a polyvinyl acetal, with a weight fraction of 2% to 30% by weight,
c. an epoxy resin, with a weight fraction of 10% to 50% by weight, and
d. a hardener.

2. The heat-activable adhesive tape of claim 1, wherein the polyvinyl acetal is polyvinyl butyral.

3. The heat-activable adhesive tape of claim 1, wherein the acrylonitrile-butadiene copolymer is at least partly hydrogenated.

4. The heat-activable adhesive tape of claim 1, wherein the acrylonitrile content of the acrylonitrile-butadiene rubber is 15% to 50% by weight.

5. The heat-activable adhesive tape of claim 1, wherein the adhesive comprises more than one epoxy resin.

6. The heat-activable adhesive tape of claim 1, wherein the adhesive comprises one or more of tackifying resins, accelerators, dyes, carbon black and metal powders.

7. The heat-activable adhesive tape of claim 1, wherein the adhesive crosslinks at temperatures above 150° C.

8. The heat-activable adhesive tape of claim 1 wherein the adhesive further comprises additional elastomers.

9. A method for bonding flexible printed conductor tracks which comprises bonding said flexible printed conductor tracks with the heat-activable adhesive tape of claim 1.

10. A method for bonding an article to polyimide, which comprises bonding said article to said polyamide with the heat-activable adhesive tape of claim 1.
